(19) United States
(12) Patent Application Publication
(10) Pub. No.: US 2026/0211728 A1
(43) Pub. Date: Jul. 23, 2026

(54) METHODS AND DEVICES FOR CALCULATING MEMORY USAGE OF FILES IN PROCESSES

(71) Applicant: MediaTek Singapore Pte. Ltd., Singapore (SG)

(72) Inventor: Jianjiao ZENG, Beijing (CN)

(21) Appl. No.: 19/032,201

(22) Filed: Jan. 20, 2025

(51) Int. Cl. G06F 9/50

(52) U.S. Cl. CPC G06F 9/5016

(57) ABSTRACT

A method for calculating memory usage of files in processes is provided. The method includes receiving an instruction, wherein the instruction indicates to obtain a proportion of a shared memory occupied by a current process. The method includes obtaining numbers of processes corresponding to files included in the current process through a lookup table. The method includes calculating the proportion of the shared memory occupied by the current process based on the numbers of the processes.

### BACKGROUND OF THE INVENTION

### Field of the Invention

The present disclosure generally relates to the field of memory and computing. More specifically, aspects of the present disclosure relate to methods and devices for calculating memory usage of files in processes.

### Description of the Related Art

With development of terminal technologies, terminal devices have become indispensable items in people's daily life. However, in the process of using a terminal device, as the number of opened applications increases, increasingly more processes run, and increasingly more memory is used. As a result, the available memory of a system decreases, and the problem of being out of memory occurs. Consequently, frame freezing in the terminal device may occur.

Understanding terminal memory usage distribution is an important part of system optimization or operation decision-making. The files representing the memory type may be shared by multiple processes. How to efficiently and accurately count the proportion of shared memory occupied by files in each process is particularly important.

Therefore, there is a need for methods and devices for calculating the memory usage of files in processes to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the methods and devices for calculating memory usage of files in processes provided in the present disclosure may enable the device to efficiently and accurately count the proportion of the shared memory occupied by files in each process.

In an exemplary embodiment, a method for calculating memory usage of files in processes is provided. The method is executed by a processor of an electronic device. The method comprises receiving an instruction, wherein the instruction indicates to obtain a proportion of a shared memory occupied by a current process. The method comprises obtaining numbers of processes corresponding to files included in the current process through a lookup table. The method comprises calculating the proportion of the shared memory occupied by the current process based on the numbers of the processes.

In some embodiments, before receiving the instruction, the method further comprises registering callback functions corresponding to Kernel Application Programming Interfaces (APIs) related to the files in a kernel space layer. The method further comprises recording association information between the processes and the files in the lookup table according to the callback functions.

In some embodiments, the step of recording the association information between the processes and the files in the lookup table according to the callback functions further comprises determining whether the lookup table has recorded a first file when the callback functions indicate that the first file is opened or duplicated in the current process and recording the first file in the lookup table and adding 1 to a file count value corresponding to the current process when the lookup table does not record the first file.

In some embodiments, the method further comprises detecting whether the file count value exceeds a first preset threshold. The method further comprises sending a first notification message to a user to notify the user that the file count value exceeds a first preset threshold when the file count value exceeds the first preset threshold.

In some embodiments, the method comprises detecting whether a memory size occupied by the files included in the current process exceeds a second preset threshold when the file count value does not exceed the first preset threshold. The method further comprises sending a second notification message to the user to notify the user that the memory size occupied by the files included in the current process exceeds the second preset threshold when the memory size occupied by the files included in the current process exceeds the second preset threshold

In some embodiments, the method further comprises detecting whether a total memory size occupied by the processes exceeds a third preset threshold when the memory size occupied by the files included in the current process does not exceed the second preset threshold. The method further comprises sending a third notification message to the user to notify the user that the total memory size occupied by the processes exceeds the third preset threshold when the total memory size occupied by the processes exceeds the third preset threshold.

In some embodiments, the step of recording the association information between the processes and the files in the lookup table according to the callback functions further comprises: determining whether the lookup table has recorded a second file when the callback functions indicate that the second file is closed in the current process; and decrementing a file count value corresponding to the current process by 1 when the lookup table has recorded the second file.

In some embodiments, the step of recording the association information between the processes and the files in the lookup table according to the callback functions further comprises: determining whether the current process is a type of shared memory that needs to be recorded when the callback functions indicate that a third file is forked from the current process to a new process; and copying the third file in the current process to the new process in the lookup table and adding 1 to a file count value corresponding to the new process when the third file is the type of shared memory that needs to be recorded.

In some embodiments, the step of recording the association information between the processes and the files in the lookup table according to the callback functions further comprises: determining whether the current process is a type of shared memory that needs to be recorded when the callback functions indicate that a fourth file exits or is killed from the current process; and removing the fourth file from the lookup table and decrementing a file count value corresponding to the current process by 1 when the current process is the type of shared memory that needs to be recorded.

In some embodiments, the lookup table has a structure of a red-black tree.

In an exemplary embodiment, a device for calculating memory usage of files in processes is provided. The device comprises one or more processors and one or more computer storage media for storing one or more computer-readable instructions. The processor is configured to drive the computer storage media to execute the following tasks. The processor receives an instruction, wherein the instruction indicates to obtain a proportion of a shared memory occupied by a current process. The processor obtains numbers of processes corresponding to files included in the current process through a lookup table. The processor calculates the proportion of the shared memory occupied by the current process based on the numbers of the processes.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram of the operation between a user space layer and a kernel space layer in an electronic device according to an embodiment of the disclosure.

FIG. 2 is a flowchart illustrating adding association information in the lookup table according to an embodiment of the present disclosure.

FIG. 3 is a flowchart illustrating reducing association information in the lookup table according to an embodiment of the present disclosure.

FIG. 4 is a flowchart illustrating forking association information in the lookup table according to an embodiment of the present disclosure.

FIG. 5 is a flowchart illustrating removing association information from the lookup table according to an embodiment of the present disclosure.

FIG. 6 is a flowchart illustrating a method for calculating memory usage of files in processes according to an embodiment of the present disclosure.

FIG. 7 shows how to calculate the proportion of the shared memory occupied by the current process based on the number of the processes according to an embodiment of the present disclosure.

FIG. 8 illustrates an exemplary operating environment for implementing embodiments of the present disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

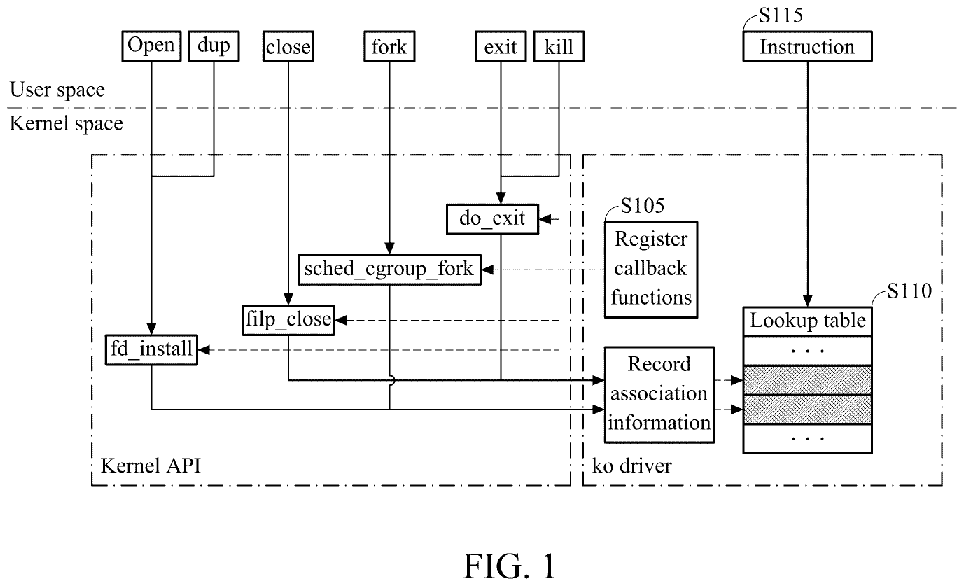

FIG. 1 is a schematic diagram of the operation between a user space layer and a kernel space layer in an electronic device according to an embodiment of the disclosure.

As shown in FIG. 1, functions of operating files in the user space layer may call Kernel Application Programming Interfaces (APIs) in the Kernel space layer. An API is a set of clearly defined methods of communication between various software components. An API specification commonly includes, without limitation: routines, data structures, object classes, variables, remote calls and/or any number of other software constructs commonly defined within the computing arts.

As a brief aside, user space layer is a portion of system memory that a processor executes user processes from. The user space layer is relatively freely and dynamically allocated for application software and a few device drivers. The Kernel space layer is a portion of memory that a processor executes the kernel from. The Kernel space layer is strictly reserved (usually during the processor boot sequence) for running privileged operating system (O/S) processes, extensions, and most device drivers. For example, each user space process normally runs in a specific memory space (its own “sandbox”), and cannot access the memory of other processes unless explicitly allowed. In contrast, the kernel is the core of a computer's operating system; the kernel can exert complete control over all other processes in the system.

The functions of operating files may at least comprise: open, dup, close, fork, exit and kill, and the Kernel APIs may at least comprise: fd_install, filp_close, sched_cgroup_fork and do_exit. For example, the Kernel API, fd_install, is called in the kernel space layer when a file is opened or duplicated in the user space layer. The Kernel API, filp_close, is called in the kernel space layer when a file is closed in the user space layer. The Kernel API, sched_cgroup_fork, is called in the kernel space layer when a file is forked in the user space layer. The Kernel API, do_exit, is called in the kernel space layer when a file exits or is killed in the user space layer. It should be noted that the functions of operating files and the Kernel APIs are not used to limit the present disclosure, and those skilled in the art can make appropriate replacements or adjustments according to this embodiment.

A ko driver in the kernel space layer may register callback functions corresponding to the APIs related to the files in step S105. The callback functions are kprobe probe functions and are used to track function execution status.

In response to the APIs being triggered, the callback functions corresponding to the APIs are executed in the kernel space layer, and the callback data is returned to the ko driver after the callback functions are executed. Specifically, the callback data at least comprises a process identity (PID) of each process when the APIs related to the files are executed, names of the file, sizes of the files and types of shared memory corresponding to the files.

Then, the ko driver records association information between the processes and the files in a lookup table according to the callback functions in step S110. Specifically, when a Kernel APIs, fd_install or sched_cgroup_fork, related to a file is called, the ko driver records that the file is added in the current process in the lookup table. When a Kernel API, filp_close or do_exit, related to a file is called, the ko driver records that the file is deleted from the current process in the lookup table. In addition, the callback data may be also recorded in the lookup table. In some embodiments, the lookup table has the structure of a red-black tree.

When the ko driver receives an instruction from the user space layer in S115, the ko driver obtains numbers of processes corresponding to files included in the current process through a lookup table and calculates a proportion of the shared memory occupied by the current process based on the numbers of the processes, wherein the instruction indicates to obtain the proportion of the shared memory occupied by the current process.

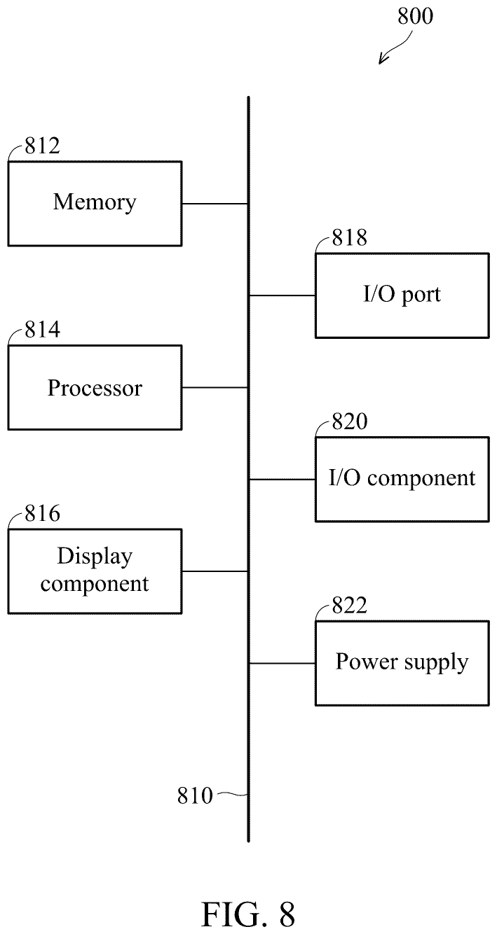

It should be understood that the electronic device shown in FIG. 1 is an example of the device for calculating memory usage of files in processes. The electronic device shown in FIG. 1 may be implemented through any type of electronic device, such as the electronic device 800 described with reference to FIG. 8, for example.

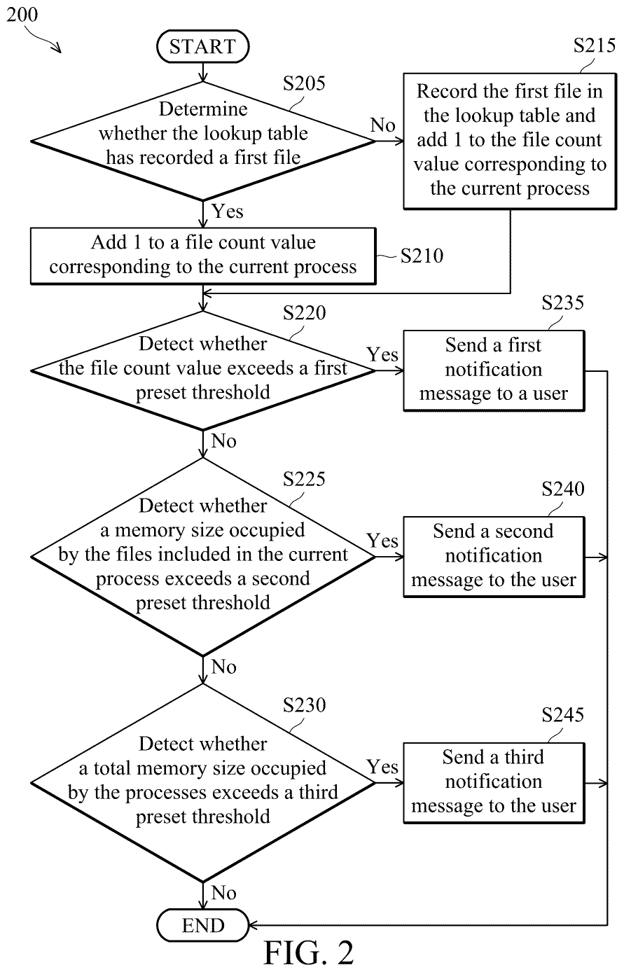

FIGS. 2~6 introduce how the ko driver records the association information between the processes and the files in the lookup table according to different callback functions.

FIG. 2 is a flowchart 200 illustrating adding association information in the lookup table according to an embodiment of the present disclosure. This flowchart 200 is executed by the ko driver in FIG. 1.

In step S205, the ko driver determines whether the lookup table has recorded a first file when the callback functions indicate that the first file is opened or duplicated in the current process.

When the lookup table has recorded the first file (“Yes” in step S205), in step S210, the ko driver adds 1 to a file count value corresponding to the current process.

When the lookup table does not record the first file (“No” in step S205), in step S215, the ko driver records the first file in the lookup table and adds 1 to the file count value corresponding to the current process.

In another embodiment, in step S205, the ko driver may further determine whether the lookup table has recorded the current process. When the lookup table does not record the current process, the ko driver records the current process in the lookup table.

In yet another embodiment, before the ko driver determines whether the lookup table has recorded the first file, the ko driver may further determine whether the first file is the type of shared memory that needs to be recorded. When the ko driver determines that the first file is the type of shared memory that needs to be recorded, step S205 is executed. Otherwise, the flowchart is ended.

Then, in step S220, the ko driver detects whether the file count value exceeds a first preset threshold.

When the file count value exceeds the first preset threshold (“Yes” in step S220), in step S235, the ko driver sends a first notification message to a user to notify the user that the file count value exceeds a first preset threshold, so that the user may perform corresponding processing.

When the file count value does not exceed the first preset threshold (“No” in step S220), in step S225, the ko driver detects whether a memory size occupied by the files included in the current process exceeds a second preset threshold.

When the memory size occupied by the files included in the current process exceeds the second preset threshold (“Yes” in step S225), in step 240, the ko driver sends a second notification message to the user to notify the user that the memory size occupied by the files included in the current process exceeds the second preset threshold, so that the user may perform corresponding processing.

When the memory size occupied by the files included in the current process does not exceed the second preset threshold (“No” in step S225), in step S230, the ko driver detects whether a total memory size occupied by the processes exceeds a third preset threshold.

When the total memory size occupied by the processes exceeds the third preset threshold (“Yes” in step S230), in step S245, the ko driver sends a third notification message to the user to notify the user that the total memory size occupied by the processes exceeds the third preset threshold, so that the user may perform corresponding processing.

When the total memory size occupied by the processes does not exceed the third preset threshold (“No” in step S230), the flowchart is ended.

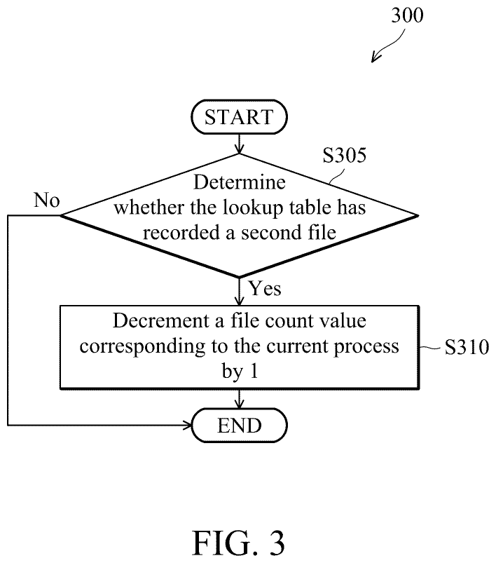

FIG. 3 is a flowchart 300 illustrating reducing association information in the lookup table according to an embodiment of the present disclosure. This flowchart 300 is executed by the ko driver in FIG. 1.

In step S305, the ko driver determines whether the lookup table has recorded a second file when the callback functions indicate that the second file is closed in the current process.

When the lookup table has recorded the second file (“Yes” in step S305), in step S310, the ko driver decrements a file count value corresponding to the current process by 1.

When the lookup table does not record the second file (“No” in step S305), the flowchart is ended.

In yet another embodiment, before the ko driver determines whether the lookup table has recorded the second file, the ko driver may further determine whether the second file is the type of shared memory that needs to be recorded. When the ko driver determines that the second file is the type of shared memory that needs to be recorded, step S305 is executed. Otherwise, the flowchart is ended.

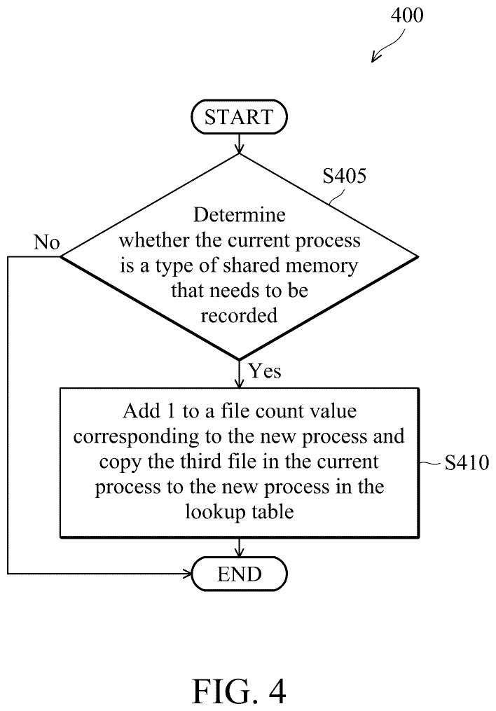

FIG. 4 is a flowchart 400 illustrating forking association information in the lookup table according to an embodiment of the present disclosure. This flowchart 400 is executed by the ko driver in FIG. 1.

In step S405, the ko driver determines whether the current process is the type of shared memory that needs to be recorded when the callback functions indicate that a third file is forked from the current process to a new process.

When the third file is the type of shared memory that needs to be recorded (“Yes” in step S405), in step S410, the ko driver adds 1 to a file count value corresponding to the new process and copies the third file in the current process to the new process in the lookup table.

When the current process does not belong to the type of shared memory that needs to be recorded (“No” in step S405), the flowchart is ended.

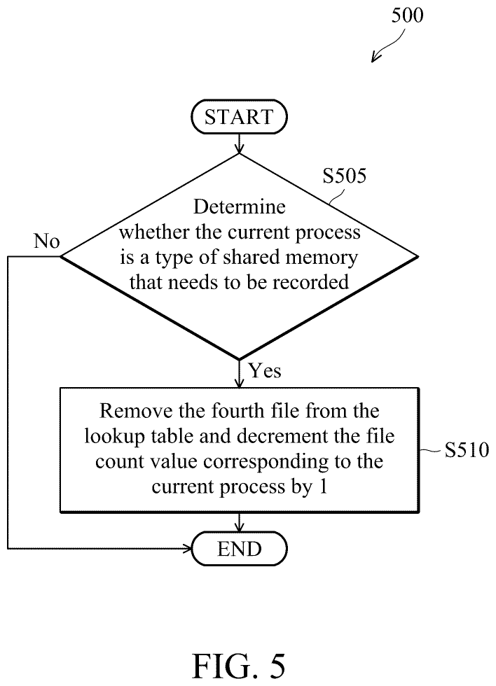

FIG. 5 is a flowchart 500 illustrating removing association information from the lookup table according to an embodiment of the present disclosure. This flowchart 500 is executed by the ko driver in FIG. 1.

In step S505, the ko driver determines whether the current process is the type of shared memory that needs to be recorded when the callback functions indicate that a fourth file exits or is killed from the current process.

When the current process is the type of shared memory that needs to be recorded (“Yes” in step S505), in step S510, the ko driver removes the fourth file from the lookup table and decrements the file count value corresponding to the current process by 1.

When the current process does not belong to the type of shared memory that needs to be recorded (“No” in step S505), the flowchart is ended.

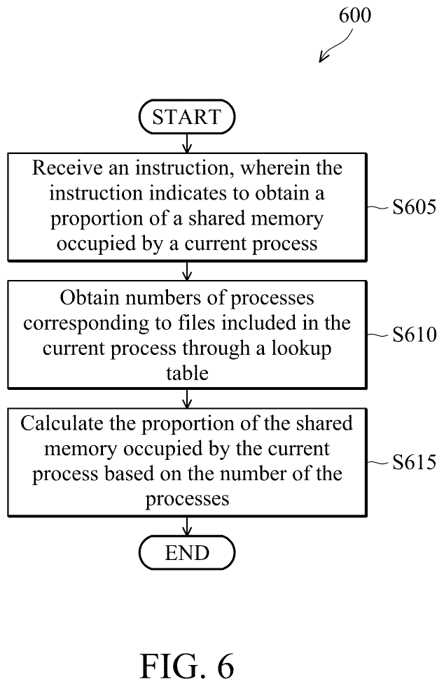

FIG. 6 is a flowchart 600 illustrating a method for calculating memory usage of files in processes according to an embodiment of the present disclosure. This flowchart 500 is executed by the ko driver in FIG. 1 or a processor of an electronic device.

In step S605, the processor receives an instruction, wherein the instruction indicates to obtain a proportion of a shared memory occupied by a current process.

Then, in step S610, the processor obtains numbers of processes corresponding to files included in the current process through a lookup table, wherein the lookup table has the structure of a red-black tree.

In step S615, the processor calculates the proportion of the shared memory occupied by the current process based on the number of the processes.

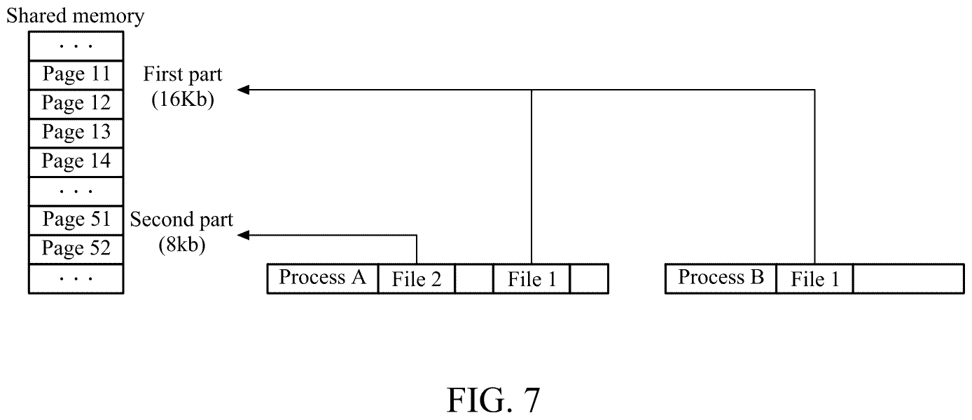

FIG. 7 shows how to calculate the proportion of the shared memory occupied by the current process based on the number of the processes according to an embodiment of the present disclosure.

As shown in FIG. 7, it is assumed that the shared memory is divided into a first part and a second part, the size of the first part is 16 Kb, and the size of the second part is 8 Kb. Process A includes File 1 and File 2, and Process B includes File 1. According to the flowcharts in FIGS. 2 to 6, the processor may obtain how many processes each file is held by based on the numbers of processes corresponding to File 1 and File 2 through the lookup table.

In FIG. 7, File 1 is held by Process A and Process B, and File 2 is held by Process B. In other words, the number of processes corresponding to File 1 is 2 and the number of processes corresponding to File 2 is 1. The proportion of the shared memory occupied by Process A and Process B are expressed by the following formulas.

$$Process A = \frac{Size of the first part}{Number of processes corresponding to File 1} + \frac{Size of the second part}{Number of processes corresponding to File 2} = \frac{16 Kb}{2} + \frac{8 Kb}{1} = 16 Kb$$

$$Process B = \frac{Size of the first part}{Number of processes corresponding to File 1} = \frac{16 Kb}{2} = 8 Kb$$

As mentioned above, the devices and methods for calculating memory usage of files in processes proposed in the present disclosure may registers callback functions corresponding to Kernel APIs related to the files, and records the association information between all processes and files in real time. Based on the association information, the proportion of the shared memory occupied by each process can be quickly calculated, which can greatly reduce the calculation time.

It should be noted that the embodiment in FIG. 1 can be implemented in hardware, software, firmware or any combination thereof. For example, the ko driver may each be implemented as computer program codes executed by one or more processors. Alternatively, the ko driver may be implemented as hardware logic/circuit respectively.

Having described embodiments of the present disclosure, an exemplary operating environment in which embodiments of the present disclosure may be implemented is described below. Referring to FIG. 8, an exemplary operating environment for implementing embodiments of the present disclosure is shown and generally known as an electronic device 800. The electronic device 800 is merely an example of a suitable computing environment and is not intended to limit the scope of use or functionality of the disclosure. Neither should the electronic device 800 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 8, the electronic device 800 may include a bus 810 that is directly or indirectly coupled to the following devices: one or more memories 812, one or more processors 814, one or more display components 816, one or more input/output (I/O) ports 818, one or more input/output components 820, and an illustrative power supply 822. The bus 810 may represent one or more kinds of busses (such as an address bus, data bus, or any combination thereof). Although the various blocks of FIG. 8 are shown with lines for the sake of clarity, and in reality, the boundaries of the various components are not specific. For example, the display component such as a display device may be considered an I/O component and the processor may include a memory.

The electronic device 800 typically includes a variety of computer-readable media. The computer-readable media can be any available media that can be accessed by electronic device 800 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 800. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 812 may include computer-storage media in the form of volatile and/or nonvolatile memory. The memory may be removable, non-removable, or a combination thereof. Exemplary hardware devices include solid-state memory, hard drives, optical-disc drives, etc. The electronic device 800 includes one or more processors that read data from various entities such as the memory 812 or the I/O components 820. The display component(s) 816 present data indications to a user or to another device. Exemplary presentation components include a display device, speaker, printing component, vibrating component, etc.

The I/O ports 818 allow the electronic device 800 to be logically coupled to other devices including the I/O components 820, some of which may be embedded. Illustrative components include a microphone, joystick, game pad, satellite dish, scanner, printer, wireless device, etc. The I/O components 820 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 800, or any combination thereof. The electronic device 800 may be equipped with depth cameras, such as stereoscopic camera systems, infrared camera systems, RGB camera systems, or any combination thereof, to realize gesture detection and recognition. Furthermore, the electronic device 800 may be equipped with accelerometers or gyroscopes that enable detection of motion. The output of the accelerometers or gyroscopes may be provided to the display of the electronic device 800 to carry out immersive augmented reality or virtual reality.

Furthermore, the processor 814 in the electronic device 800 can execute the program code in the memory 812 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for calculating memory usage of files in processes, executed by a processor of an electronic device, and the method comprises:
receiving an instruction, wherein the instruction indicates to obtain a proportion of a shared memory occupied by a current process;
obtaining numbers of processes corresponding to files included in the current process through a lookup table; and
calculating the proportion of the shared memory occupied by the current process based on the numbers of the processes.

2. The method for calculating memory usage of files in processes as claimed in claim 1, wherein before receiving the instruction, the method further comprises:
registering callback functions corresponding to Kernel Application Programming Interfaces (APIs) related to the files in a kernel space layer; and
recording association information between the processes and the files in the lookup table according to the callback functions.

3. The method for calculating memory usage of files in processes as claimed in claim 2, wherein the step of recording the association information between the processes and the files in the lookup table according to the callback functions further comprises:
determining whether the lookup table has recorded a first file when the callback functions indicate that the first file is opened or duplicated in the current process; and
recording the first file in the lookup table and adding 1 to a file count value corresponding to the current process when the lookup table does not record the first file.

4. The method for calculating memory usage of files in processes as claimed in claim 3, further comprising:
detecting whether the file count value exceeds a first preset threshold; and
sending a first notification message to a user to notify the user that the file count value exceeds a first preset threshold when the file count value exceeds the first preset threshold.

5. The method for calculating memory usage of files in processes as claimed in claim 4, further comprising:
detecting whether a memory size occupied by the files included in the current process exceeds a second preset threshold when the file count value does not exceed the first preset threshold; and
sending a second notification message to the user to notify the user that the memory size occupied by the files included in the current process exceeds the second preset threshold when the memory size occupied by the files included in the current process exceeds the second preset threshold.

6. The method for calculating memory usage of files in processes as claimed in claim 5, further comprising:
detecting whether a total memory size occupied by the processes exceeds a third preset threshold when the memory size occupied by the files included in the current process does not exceed the second preset threshold; and
sending a third notification message to the user to notify the user that the total memory size occupied by the processes exceeds the third preset threshold when the total memory size occupied by the processes exceeds the third preset threshold.

7. The method for calculating memory usage of files in processes as claimed in claim 2, wherein the step of recording the association information between the processes and the files in the lookup table according to the callback functions further comprises:
determining whether the lookup table has recorded a second file when the callback functions indicate that the second file is closed in the current process; and
decrementing a file count value corresponding to the current process by 1 when the lookup table has recorded the second file.

8. The method for calculating memory usage of files in processes as claimed in claim 2, wherein the step of recording the association information between the processes and the files in the lookup table according to the callback functions further comprises:
determining whether the current process is a type of shared memory that needs to be recorded when the callback functions indicate that a third file is forked from the current process to a new process; and
copying the third file in the current process to the new process in the lookup table and adding 1 to a file count value corresponding to the new process when the third file is the type of shared memory that needs to be recorded.

9. The method for calculating memory usage of files in processes as claimed in claim 2, wherein the step of recording the association information between the processes and the files in the lookup table according to the callback functions further comprises:
determining whether the current process is a type of shared memory that needs to be recorded when the callback functions indicate that a fourth file exits or is killed from the current process; and
removing the fourth file from the lookup table and decrementing a file count value corresponding to the current process by 1 when the current process is the type of shared memory that needs to be recorded.

10. The method for calculating memory usage of files in processes as claimed in claim 1, wherein the lookup table has a structure of a red-black tree.

11. A device for calculating memory usage of files in processes, comprising:
one or more processors; and
one or more computer storage media for storing one or more computer-readable instructions, wherein the processor is configured to drive the computer storage media to execute the following tasks:
receiving an instruction, wherein the instruction indicates to obtain a proportion of a shared memory occupied by a current process;
obtaining numbers of processes corresponding to files included in the current process through a lookup table; and
calculating the proportion of the shared memory occupied by the current process based on the numbers of the processes.

12. The device for calculating memory usage of files in processes as claimed in claim 11, wherein before receiving the instruction, the processor further executes the following tasks:
registering callback functions corresponding to Kernel Application Programming Interfaces (APIs) related to the files in a kernel space layer; and
recording association information between the processes and the files in the lookup table according to the callback functions.

13. The device for calculating memory usage of files in processes as claimed in claim 12, wherein the step of recording the association information between the processes and the files in the lookup table according to the callback functions further comprises:
determining whether the lookup table has recorded a first file when the callback functions indicate that the first file is opened or duplicated in the current process; and
recording the first file in the lookup table and adding 1 to a file count value corresponding to the current process when the lookup table does not record the first file.

14. The device for calculating memory usage of files in processes as claimed in claim 13, wherein the processor further executes the following tasks:
detecting whether the file count value exceeds a first preset threshold; and
sending a first notification message to a user to notify the user that the file count value exceeds a first preset threshold when the file count value exceeds the first preset threshold.

15. The device for calculating memory usage of files in processes as claimed in claim 14, wherein the processor further executes the following tasks:
detecting whether a memory size occupied by the files included in the current process exceeds a second preset threshold when the file count value does not exceed the first preset threshold; and
sending a second notification message to the user to notify the user that the memory size occupied by the files included in the current process exceeds the second preset threshold when the memory size occupied by the files included in the current process exceeds the second preset threshold.

16. The device for calculating memory usage of files in processes as claimed in claim 15, wherein the processor further executes the following tasks:
detecting whether a total memory size occupied by the processes exceeds a third preset threshold when the memory size occupied by the files included in the current process does not exceed the second preset threshold; and
sending a third notification message to the user to notify the user that the total memory size occupied by the processes exceeds the third preset threshold when the total memory size occupied by the processes exceeds the third preset threshold.

17. The device for calculating memory usage of files in processes as claimed in claim 12, wherein the step of recording the association information between the processes and the files in the lookup table according to the callback functions further comprises:
determining whether the lookup table has recorded a second file when the callback functions indicate that the second file is closed in the current process; and
decrementing a file count value corresponding to the current process by 1 when the lookup table has recorded the second file.

18. The device for calculating memory usage of files in processes as claimed in claim 12, wherein the step of recording the association information between the processes and the files in the lookup table according to the callback functions further comprises:
determining whether the current process is a type of shared memory that needs to be recorded when the callback functions indicate that a third file is forked from the current process to a new process; and
copying the third file in the current process to the new process in the lookup table and adding 1 to a file count value corresponding to the new process when the third file is the type of shared memory that needs to be recorded.

19. The device for calculating memory usage of files in processes as claimed in claim 12, wherein the step of recording the association information between the processes and the files in the lookup table according to the callback functions further comprises:
determining whether the current process is a type of shared memory that needs to be recorded when the callback functions indicate that a fourth file exits or is killed from the current process; and
removing the fourth file from the lookup table and decrementing a file count value corresponding to the current process by 1 when the current process is the type of shared memory that needs to be recorded.

20. The device for calculating memory usage of files in processes as claimed in claim 11, wherein the lookup table has a structure of a red-black tree.
